(19) United States
(12) Patent Application Publication
(10) Pub. No.: US 2006/0015420 A1
(43) Pub. Date: Jan. 19, 2006

(54) Method and apparatus for covering costs of law firm out-of-pocket expenses

(76) Inventor: Steven Lundberg, Edina, MN (US)

Correspondence Address: Schwegman, Lundberg,;Woessner & Kluth, P.A., P.O. Box 2938, Minneapolis, MN, 55402, US

(21) Appl. No.: 11/152,687

(22) Filed: Jun. 14, 2005

Related U.S. Application Data
(60) Provisional application No. 60/579,416, filed on Jun. 14, 2004.

(51) Int. Cl. G06Q 10/00

(52) U.S. Cl. 705/34

(57) ABSTRACT

A method and system is disclosed including storing data regarding a plurality of law firm clients in a database, designating at least some of those clients to be billed for interest incurred financing out-of-pocket expenses, with the law firm financing an out-of-pocket expense using law firm capital or a loan from a financing source. The law firm bills a client for a particular financed out-of-pocket expenses, and determines a cost recovery fee associated with the financed out-of-pocket expense, wherein the cost recover fee is calculated or checked based on one or more criteria to help the law firm avoid charging a client more than a threshold rate. The method and system further provides that the law firm bill the client for at least a portion of the cost recovery fee as a disbursement at the same time as billing the client for the associated out-of-pocket expense, and that the client pays the law firm for the financed out-of-pocket expense and for the cost recovery fee disbursed to the client. It is further determined, using the accounting system, how long the out-of-pocket expense was financed for based on when the law firm was paid by the client and when the out-of-pocket expense was incurred, and determining an actual interest rate charged by the law firm as a result of financing the out-of-pocket cost for the client. Further the method and system provide that the law firm credit or refund to the client for any portion of the cost recovery fee charge that results in the rate exceeding the threshold rate. The threshold rate may be a usurious rate.

### RELATED APPLICATIONS

The present application claims the benefit of priority under 35 U.S.C. 119(e) of U.S. Provisional Patent Application Ser. No. 60/579,416, filed Jun. 14, 2004, which is incorporated herein by reference.

### TECHNICAL FIELD OF THE INVENTION

This application pertains generally to accounting systems for attorneys, and more particularly to payment of out-of-pocket expenses by law firms for clients.

### BACKGROUND OF THE INVENTION

Law firms are routinely called upon to pay expenses for clients, or to assume the obligation to pay an expense for a client. Such expenses include, for example, payments to experts, payments to government agencies such as patent and trademark offices or regulatory agencies, payments to courts for filing fees, payments for travel expenses, or payments to co-counsel such as foreign patent and trademark attorneys. These expenses are typically incurred by the law firm as cash out-of-pocket expenses, for example when a firm pays an expense with a check or other negotiable instrument, or when the firm charges an expense for a client on the law firm's credit card or other credit account, such as a deposit account at a patent and trademark office. Such expenses can also come in the form of an obligation to pay an out-of-pocket expense. For example, by hiring an expert or other attorney on behalf of a client, the law firm often assumes the obligation to pay such an expert or attorney whether or not the client is able to pay the law firm when reimbursement is requested from the client by the law firm.

One problem for law firms is that these out-of-pocket expenses require a substantial amount of capital. Such capital may be obtained by, for example, requiring shareholders or partners of the firm to contribute capital for this and other purposes, or by retaining earnings of the firm. The capital may also be obtained as a loan from a financing entity such as a bank or other lending sources.

Another challenge that law firms face are ethical restrictions on how they can charge for out-of-pocket expenses and other costs. Ethics typically require that a law firm cannot bill a client anything other than an actual cost incurred. In other words, a law firm cannot add a surcharge to a cost and then pass that along to the client as a so-called “disbursement.” For example, a law firm cannot add a 20% up charge to the cost of meals or travel expenses and bill that to the client as a cost or expense. This means that law firms are not able to charge clients for interest unless and until the actual amount of the interest due is known. While a law firm may wish to charge interest on the capital it uses to pay out-of-pocket expenses, the law firm does not know how much interest it can properly charge until after the client repays the out-of-pocket expense. At that point in time, however, it is undesirable for the law firm to send a second invoice to recover this interest cost due to the fact that the amount sought to be recovered it often small compared to the original invoice for services rendered in connection with the cost. Sending an invoice to recover such a small expense would be viewed negatively by the client, and also would most likely require a substantial amount of extra accounting labor for the law firm.

U.S. Pat. No. 6,363,361, entitled “COMPUTERIZED PATENT AND TRADEMARK FEE PAYMENT METHOD AND SYSTEM FOR LAW FIRMS”, and issued Mar. 26, 2002, describes methods and systems for, among other things, a party independent of the law firm charging the law firm an “up-front” cost recovery fee to cover financing costs associated with a particular out-of-pocket expense incurred by the law firm. The law firm is able to pass this up-front charge along to the client with the bill seeking reimbursement for the out-of-pocket expense. Once the law firm collects the up-front charge, it is in turn paid to the independent party, who in turn can use proceeds from the charge to cover financing costs for the underlying out-of-pocket expense. This system allows the law firm to bill the client for financing costs such as interest, and does it up-front with the bill for the associated legal services, instead of seeking the reimbursement after the out-of-pocket fee is paid by the client.

### BRIEF DESCRIPTION OF THE DRAWING

FIG. 1 illustrates a system according to one example embodiment of the inventive subject matter disclosed herein.

### DETAILED DESCRIPTION OF THE INVENTIVE SUBJECT MATTER

In the following detailed description, reference is made to the accompanying drawing that forms a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the inventive subject matter disclosed herein. Therefore, the following detailed description is not to be taken in a limiting sense, and the scope of the inventive subject matter disclosed herein is defined by the appended claims and their equivalents.

The inventive subject matter described herein provides a method and system for reimbursing a law firm for interest costs incurred as a result of advancing the law firm's own capital to pay costs, for example out-of-pocket expenses, for clients. As noted above, such expenses include, for example, payments to experts, payments to government agencies such as patent and trademark offices or regulatory agencies, payments to courts for filing fees, payments for travel expenses, or payments to co-counsel such as foreign patent and trademark attorneys.

According to one example embodiment of the inventive subject matter, a law firm is entitled to charge a client a reasonable cost without prior agreement by the client, in the same manner a law firm is entitled to charge a client for postage or photocopies or other such expenses. This charge may be interest rate charged on law firm funds used to cover an out-of-pocket expense, or a fixed fee to cover the labor or material or software cost associated with advancing the funds, or a combination of both (a fixed fee and a percentage based fee based on the amount of the disbursement). For example, if a law firm paid an expert for expert services rendered on behalf of a client in the amount of $5,000.00, and the $5,000.00 was carried by the law firm for 60 days prior to reimbursement by the client, then the law firm is entitled to charge the client a reasonable interest on the use of the $5,0000.00 on behalf of the client for 60 days. This interest represents a “cost incurred” for the client, as the funds required to carry the expense could otherwise be used by the law firm for other investments or to purchase equipment or any other such purpose. Charging interest for use of this law firm capital is in contrast with charging interest on a law firm invoice that is overdue. In such a case, the interest charged is on legal fees and not charged only in relation to an out-of-pocket cost incurred by the law firm, and therefore is or may be subject to different ethical considerations.

Furthermore, even if the ethical considerations do not preclude a law firm from charging a client to cover the cost of capital (such as an percentage fee to cover the cost of interest paid or lost by the firm) used to pay client fees, the payment of such out-of-pocket fees are considered by the IRS as essentially loans to clients, and as such the law firm may be considered a lender subject to usury and other consumer credit laws and regulations. Thus, if a law firm charges a client an interest fee to recover the cost of capital for out-of-pocket expenses advanced, the law firm is likely considered a lending entity subject to usury and consumer credit laws. These laws and regulations may limit or restrict a law firm's ability to charge interest, or regulate the disclosures that a law firm must make to a client. Many usury laws even provide for criminal penalties.

According to one example embodiment of the inventive subject matter, there is provided a method and apparatus that allows for charging a client for an interest cost up-front. According to this method and system, a law firm seeks reimbursement for payment of an out-of-pocket cost in the form of a percentage of the out-of-pocket cost (alone or in combination with a fixed fee), or in the form of a fixed fee with the justification or intent that the fixed fee (such as $10 or $20 per out-of-pocket fee) help cover some or all of the cost of capital used by the law firm, such as the law firm's own capital or money borrowed from a lending institution. The method and system, according to one example embodiment, operate as follows:
A law firm incurs an out-of-pocket expense for a client (such out-of-pocket expense may be a cash expense, or in other cases, the obligation to pay a bill incurred for the client that will be paid to a third party, such as an invoice from a foreign associate of a patent firm for work done for the client).
Contemporaneously with incurring the expense, or at least prior to invoicing the client for the out-of-pocket expense, the law firm assesses an itemized cost recovery fee corresponding to the out-of-pocket expense.
The cost recovery fee is assessed, in one embodiment, in order that the law firm recovers all or at least a portion of the cost of the capital used to pay or cover the out-of-pocket expense. Such cost recovery fee may be assessed as a fixed fee, as a percentage fee, or as a combination of such fees, or as a fixed fee that varies according to ranges of amounts of out-pocket expenses. Further, in another embodiment such cost recovery fee may be selected from one of a plurality of different possible cost recovery fees, or calculated, based on how long a particular client is expected to take to repay the law firm for the out-of-pocket expense.
Appropriate accounting entries are made to track the assessed cost recovery fee.
The law firm bills the client for the expense and the corresponding assessed cost recovery fee as disbursements, preferably in the same invoice or at least bills the client the assessed cost recovery fee prior to reimbursement of the expense by the client (or alternatively only a portion of it).
The law firm receives payment by the client of the expense and the assessed cost recovery fee, typically in the same payment for the same invoice the expense and assessed cost recovery fee, whereby the client reimburses the law firm for the expense and also reimburses the law firm for the assessed cost recovery fee.
The actual carry period for the expense is determined by calculating the time from the point the expenses was incurred/advanced by the firm until the time reimbursement for the expense was received or when it is known that reimbursement will be received, such as if a client has a retainer and it is known the retainer will be used to pay the out-of-pocket expense as soon as the invoice is issued or completed. The time that the firm incurred/advanced the fee can be considered either the time that the firm undertakes the commitment to pay such a fee, such as when a check is printed or mailed, or when a charge on the law firm's credit card is made on behalf of the client. Or the time the fee was incurred/advanced might be considered the day or time at which the firm actually commits its cash, such as when a check clears. In an alternative embodiment, the actual carry period is not determined, but a determination is made to make sure that the carry period is no shorter than a particular period. For instance, it may be determined after the client has paid, or when the time of payment is known, if the out-of-pocket expense will be carried less than a certain time period.
Once the actual carry period is known, or when it is known the carry period will be no shorter than a particular length, the maximum possible annual interest rate charged to the client can be determined. It is noted that this maximum possible (or actual) annual (or other period) interest rate can, in some cases, be determined even prior to the preparation of the invoice, if, for instance, it is known when the invoice will be paid. As noted above, such may be known if the client has a retainer that can be debited immediately upon issuance of the invoice, or if it is known that a client will be paying or, alternatively, typically pays an invoice, within a certain length of time after the invoice is issued. In one example embodiment, a maximum annual interest rate may be determined as follows:
   A law firm charges a $25 fixed (or flat rate) fee as a cost recovery fee. $15 of this cost recovery fee is for the purpose of recovering the cost of the capital used to pay the fee. The other $10 is fairly attributed to labor, materials and software costs, or other such non-interest costs. The period of time (or maximum period of time) that the fee is (or will be) carried is known to be one month. The amount of the out-of-pocket fee is $100. The annualized interest rate is therefore computed as follows. $15/$100=15%. Therefore, if the carry period were one year, the interest rate would be 15%. In this case the carry period is only 1/12 year. Thus, the annual interest rate is 12×15%, or 180%. If the top non-usurious rate were 24% in a particular state, this rate would be usurious, in fact 156% over the limit. For a one-month carry, the maximum percentage of the out-of-pocket expense that could be legally charged would be 2%, or $2.
   Alternatively, if the law firm charges a fixed fee of $10 to cover labor and other non-interest costs, and 1% of the out-of-pocket expense, for instance $1 in this case, then the minimum carry required in order for this rate to be non-usurious is ½ month. At a ½ month carry, the annualized rate is 1%×24=24%, the maximum allowed non-usurious rate in this example. If the carry were only one week, then the rate would be 52×1%, or 52%, a usurious rate.
   Alternatively, a law firm may charge a cost recovery fee of 2% of the out-of-pocket expense, with a $10 minimum, and attribute up to $10 of the amount of the fee to labor and other non-interest costs. In this example, if the out-of-pocket expense were $1000, the total fee would be $20, with $10 allocated to non-interest costs, and $10 allocated to interest recovery. This is 1% of the out-of-pocket expense, allowing that the carry would have to be at least two weeks in order for the rate to be non-usurious assuming a 24% maximum rate.
If the assessed cost recovery fee exceeds the maximum non-usurious amount allowed in a particular locale, then one or more of the following options, or others are taken:
   If is known prior to billing the fee to the client that a usurious rate will result from the billing (for instance it is known that the out-of-pocket expense will be paid for from a retainer and there will be less than 2 weeks carry), then the cost recovery fee can be adjusted or eliminated before billing or refunded after billing or collection such that the rate does not exceed the usurious rate limit.
   If it is only known after the billing takes place, after or before collection, then the client can be credited or refunded an amount of the cost recovery fee that will result in the cost recovery fee being below the usurious rate limit.
If it is known that a client is a consumer that qualifies for the protection of a federal or state law requiring disclosure of interest rate information, or other such paperwork or obligations for the law firm, then the client can be exempted from being charged any interest whatsoever, so that there is no reason to comply with such undesirable regulations.
According to one example embodiment, the carry period assumed for a particular client is adjusted from time to time so that the assessed cost recovery fee for out-of-pocket expenses incurred for the client provide proceeds that match as closely as is possible the actual interest cost incurred for the typical expense advanced for that client—thus, clients that pay promptly will be assessed lower fees than those clients that typically take a long time to pay. Further, the cost recovery fee charged for a particular client can be changed from time to time to make sure it does not exceed usury law limits.

According to one alternate embodiment, instead of the law firm assessing the cost recovery fee, a party independent of the law firm agrees with the law firm to cover its interest expenses associated with funding of out-of-pocket expensed, and the law firm may pass this third party fee along to its client for reimbursement, such as disclosed in U.S. Pat. No. 6,363,361, entitled “COMPUTERIZED PATENT AND TRADEMARK FEE PAYMENT METHOD AND SYSTEM FOR LAW FIRMS”, and issued Mar. 26, 2002, or described in U.S. Provisional Patent Application entitled “METHOD AND SYSTEM FOR COVERING COSTS OF LAW FIRM OUT-OF-POCKET EXPENSES”, and filed Jun. 7, 2004, by Steven W. Lundberg. According to one example embodiment, the assessed cost recovery fee has a first component that is intended to cover the actual interest cost incurred for the particular out-of-pocket expense, and a second component that is intended to compensate the independent party for its services in connection with supplying the software and/or services required to effectuate the described method and system. The first component can be determined by estimating the expected carry period for a particular expense and, using a reasonable interest rate, determining the expected interest cost incurred by the law firm. The second component can be a fixed charge, such as $5/per transaction, or it may be a percentage of the expense itself, such as 1.5%. For example, if the transaction was to cover a $1000.00 expense, the second component may be $15.00. Alternatively, the assessed cost recovery fee may not include a second component, and the independent party could be rewarded for its services or software in another way. For example, the independent party may be paid a fixed monthly fee for providing its services by the law firm such that the law firm and not the client incur the cost of the service or software. Or, assessing a surcharge or premium on the reasonable interest rate used to determine the first component may pay the independent party. For instance, if a reasonable interest rate was 5%, the first component may be determined using a 6% rate, and the extra 1% would result in excess proceeds assessed on each out-of-pocket expense that the independent party would keep after reimbursing the law firm for actual costs incurred. Or, the excess proceeds could be obtained by assuming a longer carry period than was expected. In any case, since the law firm is not obtaining reimbursement for anything other than its actual cost, it may receive such reimbursement ethically and without requiring prior agreement with the client.

According to yet another example embodiment, the method and system provides:
Storing data regarding a plurality of law firm clients in a database;
Designating at least some of those clients to be billed for interest incurred financing out-of-pocket expenses;
The law firm financing an out-of-pocket expense using law firm capital or a loan from a financing source;
The law firm billing a client for a particular financed out-of-pocket expenses;
The law firm charging a cost recovery fee associated with the financed out-of-pocket expense;
Determining if the interest portion of the cost recovery fee will be or was usurious;
Preventing the billing of a known usurious rate, or, once payment is received or the period is otherwise known refunding a portion of the cost-recovery-fee to clients if the actual carry period results in a usurious rate.
The law firm billing the client for at least a portion of the cost recovery fee as a disbursement at the same time as billing the client for the associated out-of-pocket expense;
The client paying the law firm for the financed out-of-pocket expense and for the cost recovery fee disbursed to the client;
Determining how long the out-of-pocket expense was financed for based on when the law firm was paid by the client and when the out-of-pocket expense was incurred, and determining if the rate was usurious if not previously determined; and
Making proper refund or other adjustment to keep the rate from being usurious.

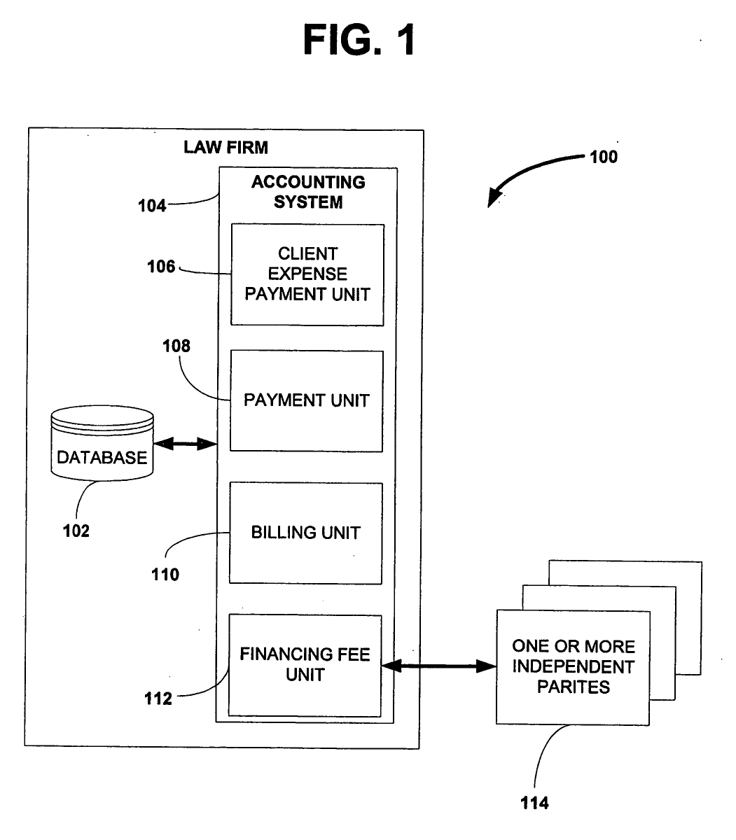

According to another example embodiment illustrated in FIG. 1, there is provided a system 100 including:
A database 102 retaining data on a plurality of law firm clients, where at least some of those clients are designated to be billed a cost recovery fee including a portion intended to or in fact providing funds to cover interest incurred or lost financing out-of-pocket expenses;
An accounting system 104 for the law firm adapted to pay or to issue a check or make an entry representing an out-of-pocket expense for a client 106, wherein the out-of-pocket expense is paid or is to be paid using law firm capital (e.g. cash) or a loan from a financing source;
The accounting system 104 for the law firm further adapted to bill a client for a particular financed out-of-pocket expenses 110 on a client bill or invoice (along with the corresponding cost recovery fee in at least one example embodiment);
The accounting system 104 (or system 104 working in conjunction with another computing system) further adapted to process (for example determine/create and/or record as a disbursement for the client) a cost recovery fee associated with the financed out-of-pocket expense 112, wherein the cost recovery fee is assessed either by the law firm or by an independent party 114 (independent of the law firm) and includes at least a portion that is billed for recovery of a cost of capital for advancing the out-of-pocket expense;
In one example embodiment the accounting system 104 (or an auxiliary computer system or remote or other computer system) adapted to check the cost recovery fee or determine the cost recovery fee to be billed on a particular matter for a particular client (or check for any cost recovery fee billed to a particular client or type/profile of client such as a fast pay client or slow pay client) such that it will not result in a usurious rate being charged (or another threshold rate less than a usurious rate that the law firm wishes to keep the rate under, such as, for instance, no more than 2 percentage points over prime), as for instance taught hereinabove, for one or more states in which the law firm practices law, or optionally such that it will not result in the law firm being subjected to consumer credit regulations or laws if the client is a consumer protected by such laws either federally or at the state level—as a result of the check applied the cost recovery fee may be reduced or adjusted so that it does not result in a usurious rate, or an interest component of the fee may be eliminated for a particular client so that the law firm is not subjected to consumer credit laws and regulations;
The accounting system 104 for the law firm adapted to bill the client for at least a portion of the cost recovery fee (as determined with or without an adjustment or elimination of the interest portion, for example) as a disbursement, in one example embodiment at the same time as billing the client for the associated out-of-pocket expense 110 and in the same invoice so that the client has to process and pay only one invoice to pay both the out-of-pocket expense and the cost recovery fee;
The accounting system 104 adapted to post a payment 108 from a client paying the law firm for the financed out-of-pocket expense and for the cost recovery fee disbursed to the client;
The accounting system 104 or another system adapted to determine how long the out-of-pocket expense was financed (or what the minimum time it was finance for was) for based on when the law firm was paid by the client (or would be paid) and when the out-of-pocket expense was incurred 112, and determine an actual financing cost incurred by the law firm as a result of financing the out-of-pocket cost for the client 112, and if the resulting rate of interest is in excess of a threshold rate, for example a usurious rate, determining a refund or credit to provide the client so that a usurious rate or other “excessive” rate determined by the law firm or an ethics board or others, is not charged.

According to still another example embodiment of the method or system described above, the system may be implemented at least in part within or closely integrated with a law firm accounting system.

According to still another example embodiment, the law firm may use its own capital to pay for out-of-pocket expenses advanced for clients, or it may use a combination of its own capital and a loan from a financing entity such as a bank. Or, in another alternative, the law firm may use a loan from a financing entity to cover the expenses in their entirety. In any variation, the actual cost incurred in interest is determined and reimbursed to the client.

What is claimed is:

1. A method, comprising:
storing data regarding a plurality of law firm clients in a database;
designating at least some of those clients to be billed for interest incurred financing out-of-pocket expenses;
the law firm financing an out-of-pocket expense using law firm capital or a loan from a financing source;
the law firm billing a client for a particular financed out-of-pocket expenses;
the law firm determining a cost recovery fee associated with the financed out-of-pocket expense, wherein the cost recover fee is calculated or checked based on one or more criteria to help the law firm avoid charging a client more than a threshold rate;
the law firm billing the client for at least a portion of the cost recovery fee as a disbursement at the same time as billing the client for the associated out-of-pocket expense;
the client paying the law firm for the financed out-of-pocket expense and for the cost recovery fee disbursed to the client;
determining how long the out-of-pocket expense was financed for based on when the law firm was paid by the client and when the out-of-pocket expense was incurred, and determining an actual interest rate charged by the law firm as a result of financing the out-of-pocket cost for the client; and
the law firm crediting or refunding to the client for any portion of the cost recovery fee charge that results in the rate exceeding the threshold rate.

2. A method according to claim 1 further wherein the threshold rate is a usurious rate.

3. A system, comprising:
a database retaining data on a plurality of law firm clients, where at least some of those clients are designated to be billed for interest incurred financing out-of-pocket expenses;
an accounting system for the law firm adapted to pay an out-of-pocket expense for a client, wherein the out-of-pocket expense is paid using law firm capital or a loan from a financing source;
the accounting system for the law firm further adapted to bill a client for a particular financed out-of-pocket expenses;
the accounting system further adapted to determine a cost recover fee based on one or more criteria to help the law firm avoid charging a client more than a threshold rate;
the accounting system for the law firm adapted to bill the client for at least a portion of the cost recovery fee as a disbursement at the same time as billing the client for the associated out-of-pocket expense;
the accounting system adapted to post a payment from a client paying the law firm for the financed out-of-pocket expense and for the cost recovery fee disbursed to the client;
the accounting system or another system adapted to determine how long the out-of-pocket expense was financed for based on when the law firm was paid by the client and when the out-of-pocket expense was incurred, and determine an actual interest rate charged by the law firm as a result of financing the out-of-pocket cost for the client, and further adapted to determine a refund or credit amount required to reduce the cost recovery fee such that it did not charge the client above the threshold rate.

4. A system according to claim 3 further including the accounting system tracking a usurious rate and using that rate as a threshold rate.
